(19) United States
(12) Patent Application Publication
(10) Pub. No.: US 2018/0253706 A1
(43) Pub. Date: Sep. 6, 2018

(54) METHOD AND SYSTEM FOR CONVERSATIONAL INTERFACE FOR ORDERING AND CUSTOMIZATION

(71) Applicant: MASTERCARD INTERNATIONAL INCORPORATED, Purchase, NY (US)

(72) Inventors: Matthew James Miller, Redding, CT (US); Jeehoon Joshua Cho, Dublin, OH (US); Alonso Araujo, Dublin (IE)

(73) Assignee: MASTERCARD INTERNATIONAL INCORPORATED, Purchase, NY (US)

(21) Appl. No.: 15/909,262

(22) Filed: Mar. 1, 2018

Related U.S. Application Data
(60) Provisional application No. 62/465,323, filed on Mar. 1, 2017.

(51) Int. Cl. G06Q 20/10; G06Q 20/40; G06Q 30/06; G06F 17/27; G06F 17/28

(52) U.S. Cl. CPC G06Q 20/102; G06Q 20/4014; G06F 17/28; G06Q 30/0613; G06F 17/2705; G06Q 30/0627

(57) ABSTRACT

A method for ordering and customization via a conversational interface includes: storing item data entries, each item data entry including data related to a purchasable item including an item identifier, natural language values, and an item cost; receiving natural language messages from a computing device; receiving payment credentials; parsing the natural language messages to identify at least one specific natural language value; identifying, for each specific natural language value, a specific item data entry that includes the respective specific natural language value; calculating a transaction cost based on the item cost included in each specific item data entry; transmitting the calculated transaction cost and the payment credentials for processing of a payment transaction; receiving a response associated with the payment transaction indicating successful thereof; and transmitting the item identifier included in each of the specific item data entries to a computing system.

### FIELD

The present disclosure relates to a conversational interface for ordering and customization, such as the ordering of food from a restaurant, using a third party system to collect order details and payment information via the parsing of natural language for use by a merchant.

### BACKGROUND

For many consumers, the ability to order products for purchase online provides great convenience, often saving significant time that the consumer can spend doing other things. However, when it comes to ordering food, particularly from restaurants for immediate enjoyment, ordering via a website or application program can be a cumbersome and annoying process, especially when a meal offers a lot of customization. Currently, websites and application programs utilize complicated combinations of drop-down menus, checkboxes, and radio buttons, which may be difficult for a user to navigate and be assured that their order is correct.

To try and assist their customers with the complicated ordering process, some restaurants have begun to provide their customers with a conversational interface, where the customer may interact with a chatbot or other conversational program to input their order. For instance, the customer may be prompted about specific options or ingredients for an entrée, where they may be able to respond to the prompts as a way of submitting their order. However, such programs are merchant-specific, often requiring the merchant to invest significant time and resources for development thereof, which may be difficult or impossible for some merchants, particularly small businesses. In addition, such programs require the customer to provide payment information directly to the program, which may make the customer apprehensive and may also limit the payment methods that may be employed.

Thus, there is a need for a technological solution whereby a third party system may provide a conversational interface that can use natural language to capture item orders from a customer on behalf of a merchant and that may receive payment credentials for processing of a transaction for purchase of the ordered item(s), without requiring interaction between the customer and the merchant.

### SUMMARY

The present disclosure provides a description of systems and methods for ordering and customization via a conversational interface. The interface receives natural language messages from a user, which are then parsed to identify item orders and customization options for a purchase requested by the user. A cost for the order is calculated, and payment credentials for funding of the order are collected, which may also be collected via the natural language messages, through other means from the user device, or via an external system, such as the transaction account's issuer. As such, the order may be collected and transaction processed without requiring the user to interact with or provide payment credentials to the merchant.

A method for ordering and customization via a conversational interface includes: storing, in an item database of a processing server, a plurality of item data entries, wherein each item data entry includes data related to a purchasable item including at least an item identifier, one or more natural language values, and an item cost; receiving, by a receiving device of the processing server, one or more natural language messages from a computing device; receiving, by the receiving device of the processing server, payment credentials; parsing, by a parsing module of the processing server, the received one or more natural language messages to identify at least one specific natural language value; executing, by a querying module of the processing server, one or more queries on the item database to identify, for each of the at least one specific natural language value, a specific item data entry where an included natural language values corresponds to the respective specific natural language value; calculating, by a calculation module of the processing server, a transaction cost based on the item cost included in each identified specific item data entry; electronically transmitting, by a transmitting device of the processing server, at least the calculated transaction cost and the received payment credentials for processing of a payment transaction; receiving, by the receiving device of the processing server, a response associated with the payment transaction indicating successful processing of the payment transaction; and electronically transmitting, by the transmitting device of the processing server, at least the item identifier included in each of the identified specific item data entries to a computing system.

A system for ordering and customization via a conversational interface includes: an item database of a processing server configured to store a plurality of item data entries, wherein each item data entry includes data related to a purchasable item including at least an item identifier, one or more natural language values, and an item cost; a receiving device of the processing server configured to receive one or more natural language messages from a computing device, and payment credentials; a parsing module of the processing server configured to parse the received one or more natural language messages to identify at least one specific natural language value; a querying module of the processing server configured to execute one or more queries on the item database to identify, for each of the at least one specific natural language value, a specific item data entry where an included natural language values corresponds to the respective specific natural language value; a calculation module of the processing server configured to calculate a transaction cost based on the item cost included in each identified specific item data entry; and a transmitting device of the processing server configured to electronically transmit at least the calculated transaction cost and the received payment credentials for processing of a payment transaction, wherein the receiving device of the processing server is further configured to receive a response associated with the payment transaction indicating successful processing of the payment transaction, and the transmitting device of the processing server is further configured to electronically transmit at least the item identifier included in each of the identified specific item data entries to a computing system.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for ordering and customization via a conversational interface in accordance with exemplary embodiments.

FIG. 2 is a block diagram illustrating the processing server of the system of FIG. 1 for facilitating ordering and customization via a conversational interface in accordance with exemplary embodiments.

FIG. 3 is a flow diagram illustrating a process for ordering and customization via a conversational interface using the system of FIG. 1 in accordance with exemplary embodiments.

FIGS. 4A-4D are diagrams illustrating a graphical user interface of the computing device of FIG. 1 for ordering and customization through natural language messages in accordance with exemplary embodiments.

FIG. 5 is a flow chart illustrating an exemplary method for ordering and customization via a conversational interface in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

### System for Ordering and Customization via Conversational Interface

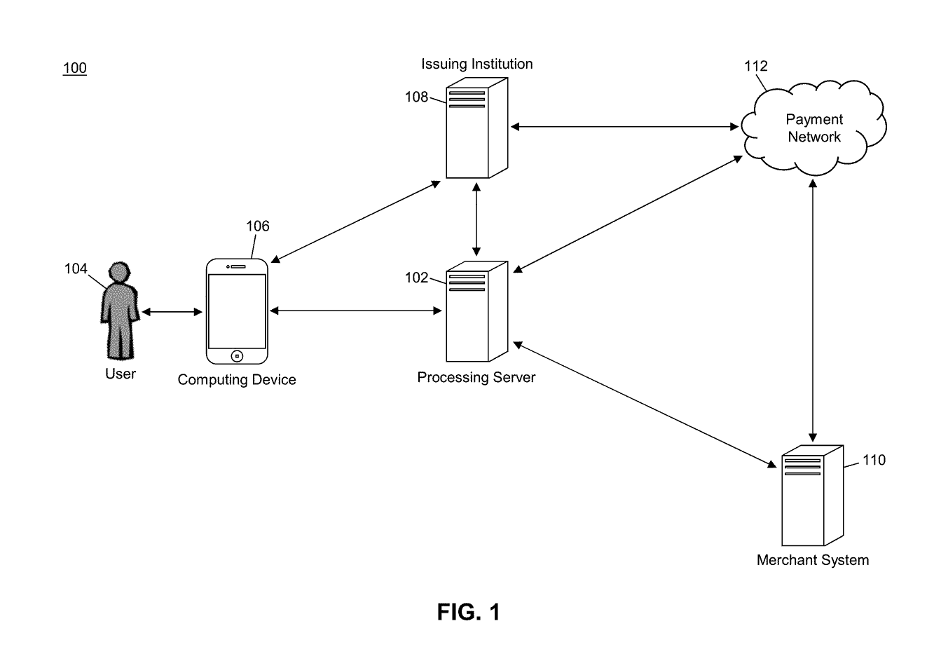

FIG. 1 illustrates a system 100 for the ordering and customization of products, such as prepared food, via the use of a conversational interface configured for parsing natural language messages submitted by a consumer.

The system 100 may include a processing server 102. The processing server 102, discussed in more detail below, may be configured to parse natural language messages to enable a user 104 to place and customize orders of items via a conversational interface for the purchase of such items. As discussed below, the processing server 102 may be a specially configured computing device and/or system that is configured to perform the functions discussed herein, which may include the parsing of natural language messages, storage and/or receipt of payment credentials, and the processing of electronic payment transactions. The user 104 may utilize a computing device 106 to interact with the processing server 102, such as to facilitate the submission of natural language messages to and receipt of messages therefrom. The computing device 106 may be any type of computing device that may be specifically configured to perform the functions discussed herein, including being configured to execute digital messaging and conversation application programs and digital payment application programs, such as a specifically configured desktop computer, laptop computer, notebook computer, tablet computer, cellular phone, smart phone, smart watch, smart television, wearable computing device, implantable computing device, etc.

In the system 100, the user 104 may use the computing device 106 to participate in a digital conversation with the processing server 102. The digital conversation may be facilitated via the use of a messaging application stored in or accessed by the computing device 106 (e.g., via cloud computing techniques) and executed thereby, to enable the user 104 to conduct a digital conversation with the same or a similar application program executed or otherwise accessed by the processing server 102. The processing server 102 may be configured to utilize a computer program programmed to participate in the digital conversation, referred to herein as a “bot” or “chatbot.” The chatbot may be configured to provide natural language messages or other data messages to the computing device 106 for presentation to the user 104 via the digital conversation. The computing device 106 and processing server 102 may be configured to exchange data messages that are superimposed or otherwise encoded with conversation messages using a suitable communication network and method. For instance, conversation messages may be exchanged using a cellular communication network, the Internet, local area network, etc., or a combination thereof. As discussed herein, a digital conversation between the user 104 and the chatbot may be comprised of the exchange of data messages between the processing server 102 and the computing device 106, such that a message “sent” by the user 104 entails the electronic transmission of a data message encoded with such message to the processing server 102 via the computing device 106 and the parsing thereof and processing by the chatbot or an associated application program.

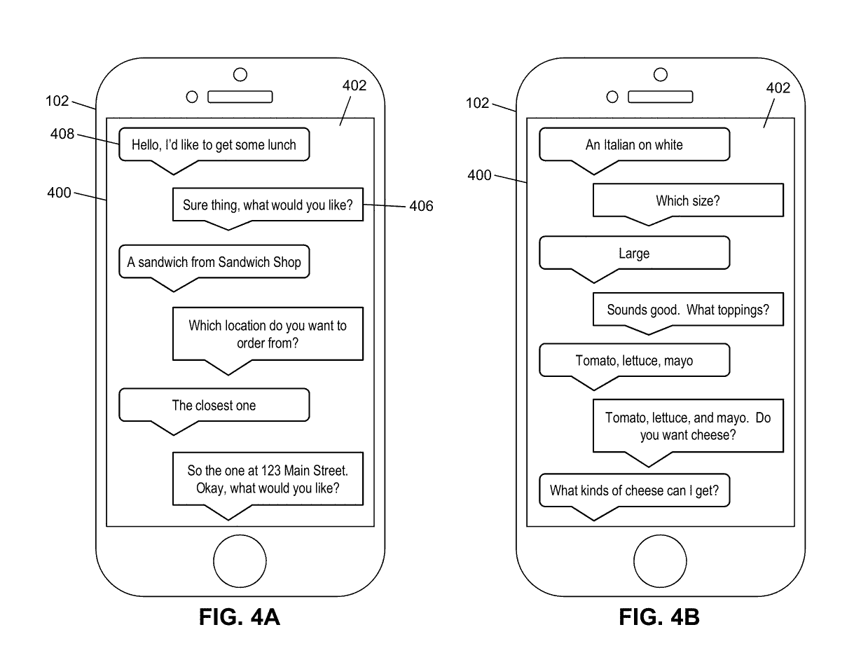

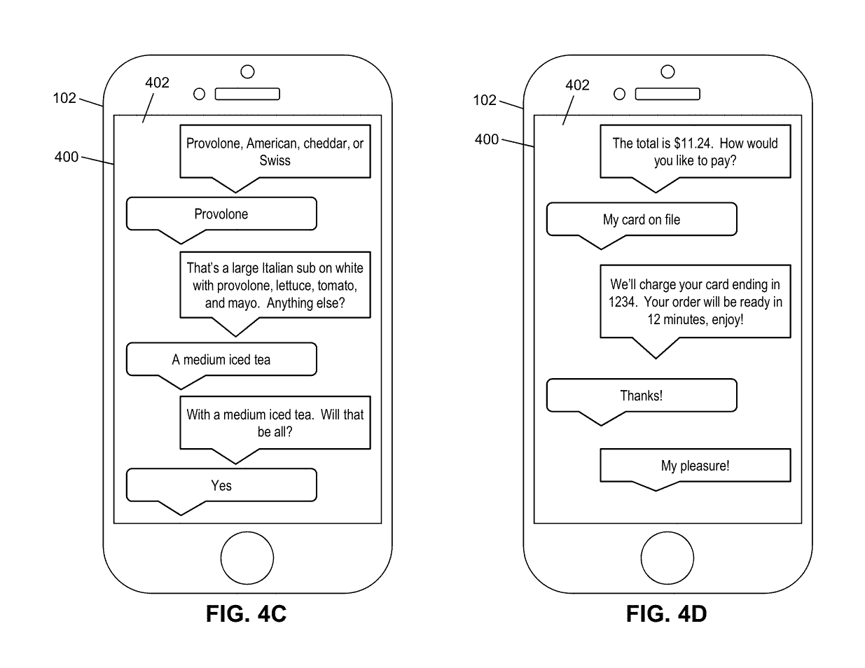

The user 104 may participate in a digital conversation with the chatbot of the processing server 102, where the user 104 may submit a customized order for the purchase of one or more items. The submission may be performed via the exchange of a plurality of natural language messages between the user 104 and the processing server 102, such as where the processing server 102 may present the user 104 with customization options, and the user 104 may respond with selections. FIGS. 4A-4D, discussed in more detail below, illustrate an example digital conversation between the user 104 and the processing server 102 for the order of food from a restaurant. The processing server 102 may receive natural language messages from the user 104, which may be messages written in a natural language and presented in a conversational format (e.g., “I'd like a large Cuban sandwich, please”), but may also include messages formatted specifically for parsing by the processing server 102 (e.g., “Cuban Sandwich, Large”).

The processing server 102 may be configured to parse the natural language messages submitted by the user 104 to identify one or more natural language values included therein. Natural language values may be data values that correspond to items that are offered for purchase by a merchant. In some cases, an item may have multiple natural language values associated therewith. For instance, in the above example, the item may be a large Cuban sandwich, where the natural language values may be both “Cuban” and “large.” In such cases, natural language values may include customization options for the respective item, such as for toppings, temperature, size, quantity, side options, etc. In some instances, the natural language values for a type of food may be dependent on the merchant, such as if merchants have preferences for how orders are submitted to their system. For example, one merchant may have extra condiments for a side item included in the natural language values for the side item, while a second merchant may have the extra condiments as their own separate items, due to charging extra for each condiment. The user 104 may also provide natural language messages that may be parsed by the processing server 102 for identification of additional natural language values for use in association with the order, such as the user's name, pickup location, pickup time, delivery location, gratuity, packaging options, etc.

Once the user 104 is satisfied with the order they have provided to the processing server 102 (e.g., via natural language message indicative thereof), the processing server 102 may electronically transmit the natural language values corresponding to the order to the appropriate merchant system 110. In some instances, the merchant system 110 may be a computing system generally associated with the merchant with which the user 104 wants to transact, such as the home office of a chain restaurant that may forward the order to the appropriate branch. In other instances, the merchant system 110 may be a point of sale system located at a merchant location where the ordered items are to be delivered or picked up, such as a direct transmission to the restaurant branch where the user 104 is picking up the item. The merchant may then fulfill the order, such as by preparing the ordered food and presenting it to the user 104 when they arrive.

The system 100 may also include an issuing institution 108. The issuing institution 108 may be a financial institution, such as an issuing bank, or other entity configured to issue transaction accounts for use in funding electronic payment transactions. The issuing institution 108 may issue a transaction account to the user 104, where the user 104 may use the transaction account to fund electronic payment transactions, including the transaction ordered via the processing server 102. The processing server 102 may be configured to receive the payment credentials associated with the transaction account, for use in a payment transaction for the purchase of the ordered item(s). In some embodiments, the payment credentials may be provisioned to the computing device 106 by the issuing institution 108, which may electronically transmit the payment credentials to the processing server 102 as a part of or separate from the digital conversation. In other embodiments, the payment credentials may be electronically transmitted to the processing server 102 by the issuing institution 108 or another third party system. For instance, the computing device 106 may provide permission to the issuing institution 108 to release the payment credentials to the processing server 102 or may provide data to the processing server 102 for obtaining the payment credentials from the issuing institution 108 or third party system. The payment credentials may include any data used in identification of the transaction account and processing thereof as part of the payment transaction, such as a transaction account number, security code, name, expiration date, transaction counter, cryptogram, etc.

In a first embodiment, the processing server 102 may provide the payment credentials to the merchant system 110 for use thereby. For instance, the payment credentials may be electronically transmitted to the merchant system 110 with the natural language values obtained via the digital conversation. The merchant system 110 may then initiate the processing of a payment transaction for purchase of the corresponding items, where the payment transaction is funded via the associated transaction account. The merchant system 110 may submit the payment credentials and other transaction data, such as a cost for the transaction, to a payment network 112 for processing thereby. The payment network 112 may receive the data and may process the payment transaction using traditional methods and systems. As part of the processing, the payment network 112 may provide a result indicating if the processing was successful or unsuccessful to the merchant system 110. If the processing is successful, the merchant may fulfill the order. If the processing was unsuccessful, the merchant system 110 may notify the processing server 102, which may, in turn, notify the user 104, such as via the digital conversation.

In a second embodiment, the processing server 102 may be configured to initiate processing of the payment transaction. In such an embodiment, the processing server 102 may be configured to identify the cost of the item or items being ordered by the user 104 and may submit the cost, payment credentials, and any other transaction data for processing. In some cases, the data may be submitted directly to the payment network 112. In other cases, the data may be submitted to a third party payment processor. In some instances, the processing server 102 may be configured to format the data in a transaction message, which may be a specially formatted data message that is formatted pursuant to one or more standards governing the exchange of financial transaction messages, such as the International Organization of Standardization's ISO 8583 or ISO 20022 standards. A transaction message may include a message type indicator, which may indicate a type of transaction message (e.g., authorization request, authorization response, etc.), and may also include a plurality of data elements configured to store transaction data. For instance, the processing server 102 may submit an authorization request to the payment network 112 using payment rails associated therewith, which may include data elements configured to store a transaction amount (e.g., corresponding to the cost of items and any associated taxes and fees). Once the payment network 112 has received the authorization request, the payment network 112 may process the payment transaction using traditional methods, and may return an authorization response to the processing server 102, which may include a data element configured to store a response code indicating if the payment transaction is approved or denied. If approved, the processing server 102 may electronically transmit the natural language values to the merchant system 110. If denied, the processing server 102 may notify the user 104 via the digital conversation, which may provide the user 104 with an opportunity to provide alternative payment.

In some embodiments, the processing server 102 may be configured to suggest merchants and/or merchant locations to the user 104 via the digital conversation and natural language messaging. For instance, in a first example, the user 104 may initiate the digital conversation by asking for a recommendation for a specific type of food, or may provide their desired item to the processing server 102 via a natural language message parsed by the processing server 102. The processing server 102 may parse the message to identify the item, and then identify a merchant that offers such an item based on data stored therein, which may then be recommended to the user 104 in a natural language message in the digital conversation. In some instances, a recommendation may also be based on additional criteria, such as by identifying the closest restaurant with a specific item, the highest rated restaurant that serves the specific item, or the restaurant with the highest rating for that specific item. In a second example, the processing server 102 may suggest a location of a specific merchant for submission of an order. For instance, the processing server 102 may receive wait times from merchant systems 110, and may recommend which location the user 104 visits for a restaurant chain based on their location wait times. In some such instances, the processing server 102 may combine the wait time information with the branch location (e.g., based on the location of the user 104, identified via the computing device 106), to recommend a location with the shortest combination of travel and wait time. For example, the processing server 102 may recommend a branch ten minutes away that has a ten minute prep and wait time over a branch that is only five minutes away but has a twenty minute prep and wait time.

In some embodiments, the processing server 102 may also provide a platform for submission of menu items. For instance, the processing server 102 may provide a programming application interface whereby a merchant system 110 that is interested in utilizing the processing server 102 may submit menu items, including via natural language messages in the digital conversation interface. The processing server 102 may parse the submitted data to identify natural language values and cost amounts for each of the items offered by the merchant for storage therein, as discussed in more detail below. As a result, a merchant may easily obtain the benefits of the processing server 102, without requiring dedication of significant time and resources as in traditional methods.

The methods and systems discussed herein enable a user 104 to order items, including placing prepared food orders for delivery or pickup, via a digital conversation and using natural language as a result of the specialized configuration of the processing server 102. As a result, users 104 may have greater ease and efficiency when ordering. In addition, the separation between processing server 102 and merchant system 110 may provide for greater utility to the user 104 and less expenditure of time and resources by the merchant systems 110. In addition, in instances where the processing server 102 may initiate the processing of payment transactions, the user 104 may be able to place an order via natural language without providing their payment credentials to the merchant entirely, thus increasing transaction account security.

### Processing Server

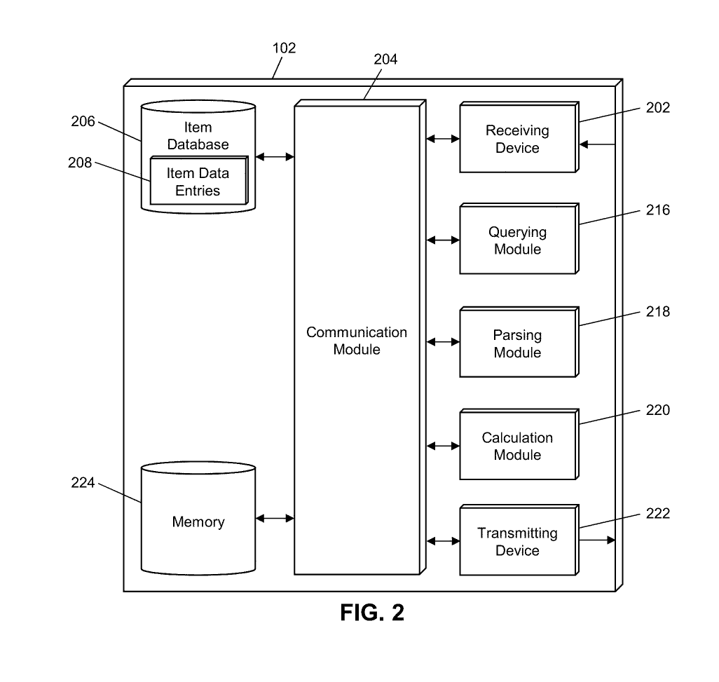

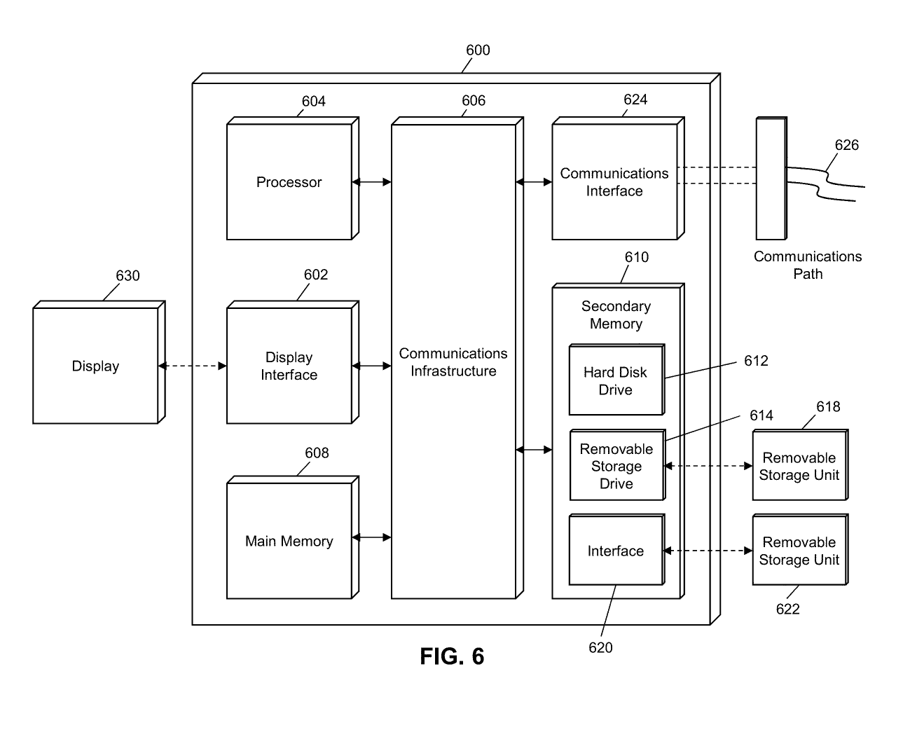

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from computing devices 106, issuing institutions 108, merchant systems 110, payment networks 112, and other systems and entities via one or more communication methods, such as near field communication, physical contact points, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by computing devices 106, which may be superimposed or otherwise encoded with natural language messages and other data messages via a digital conversation interface. In some cases, the receiving device 202 may also receive alternative data messages from computing devices 106, such as may include payment credentials or data related thereto. The receiving device 202 may be configured to receive data signals electronically transmitted by issuing institutions 108, which may be superimposed or otherwise encoded with payment credentials associated with a transaction account. The receiving device 202 may also be configured to receive data signals electronically transmitted by merchant systems 110, which may be superimposed or otherwise encoded with item data, transaction processing results, wait times, location data, and other data that may be suitable for performing the functions discussed herein.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 216, parsing module 218, calculation module 220, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include an item database 206. The item database 206 may be configured to store a plurality of item data entries 208 using a suitable data storage format and schema. The item database 206 may be a relational database that utilizes structured query language for the storage, identification, modifying, updating, accessing, etc. of structured data sets stored therein. Each item data entry 208 may be a structured data set configured to store data related to an item available for purchase from a merchant. An item data entry 208 may include at least an item identifier, one or more natural language values, and an item cost. The item identifier may be a unique data value associated with the item used by the related merchant for identification thereof. In instances where the processing server 102 may operate to serve multiple merchants, the item identifier may also be accompanied by a merchant identifier associated with the respective merchant. The one or more natural language values may be values parsed from natural language that can be used in identification of the item and its purchase, preparation, or otherwise may be relevant to the related merchant, as discussed above. The item cost may be a price to be paid (e.g., before tax, after tax, etc., as applicable) by the user 104 to purchase the item.

The processing server 102 may include a querying module 216. The querying module 216 may be configured to execute queries on databases to identify information. The querying module 216 may receive one or more data values or query strings, and may execute a query string based thereon on an indicated database, such as the item database 206, to identify information stored therein. The querying module 216 may then output the identified information to an appropriate engine or module of the processing server 102 as necessary. The querying module 216 may, for example, execute a query on the item database 206 to identify a plurality of item data entries 206 that correspond to a natural language message received from the user 104 (e.g., via the computing device 106) based on data parsed from the natural language message, such as where the natural language message includes natural language values found in the identified item data entries 208.

The processing server 102 may also include a parsing module 218. The parsing module 218 may be configured to parse data from a larger set of data to be used by other modules or engines of the processing server 102. The parsing module 218 may receive data to be parsed as input, may parse the data, and may then output the resulting data to appropriate modules or engines in the processing server 102. For instance, the parsing module 218 may be configured to parse natural language messages using suitable algorithms to identify natural language values included therein that may correspond to natural language values stored in the item data entries 208 included in the item database 206. For example, the parsing module 218 may parse the natural language message, “I'd like a pulled pork sandwich and also some fries and a medium sweet tea to drink” to identify the natural language values “pulled pork sandwich,” “fries,” and “medium sweet tea” among the other words in the message.

The processing server 102 may also include a calculation module 220. The calculation module 220 may be configured to perform calculations for the processing server 102 for the performing of the functions discussed herein. The calculation module 220 may receive instructions requesting data to be calculated, may perform the requested calculations, and may output a result of the calculations to another module or engine of the processing server 102. In some cases, data to be used in the calculation may be included in the input. In other cases, the calculation module 220 may be configured to identify such data, such as by requesting the querying module 216 to query the data from an appropriate location. The calculation module 220 may be configured to calculate a transaction amount for a payment transaction based on at least the item cost included in each item data entry 208 related to items being purchased in an order, which may be further based on fees, taxes, discounts, or other adjustments that will be apparent to persons having skill in the relevant art.

The processing server 102 may also include a transmitting device 222. The transmitting device 222 may be configured to transmit data over one or more networks via one or more network protocols. In some instances, the transmitting device 222 may be configured to transmit data to computing devices 106, issuing institution 108, merchant systems 110, and other entities via one or more communication methods, such as near field communication, physical contact points, Bluetooth, radio frequency, the Internet, etc. In some embodiments, the transmitting device 222 may be comprised of multiple devices, such as different transmitting devices for transmitting data over different networks, such as a first transmitting device for transmitting data over a local area network and a second transmitting device for transmitting data via the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to computing devices 106 that are superimposed or otherwise encoded with data messages as part of a digital conversation. In some cases, the data messages may be natural language messages, which may be predetermined (e.g., stored in memory and used as predetermined responses in the conversation) or may be procedurally generated based on applicable rules. The transmitting device 222 may also be configured to electronically transmit data signals to issuing institutions 108, which may be superimposed or otherwise encoded with data requesting payment credentials associated with a transaction account, such as account identification and/or authentication data. The transmitting device 222 may be further configured to electronically transmit data signals to merchant systems 110, which may be superimposed or otherwise encoded with item identifiers associated with items selected for purchase by a user 104, and may also be superimposed or otherwise encoded with payment credentials or data indicating successful processing of a payment transaction related therewith. The transmitting device 222 may be further configured to electronically transmit transaction messages to a payment network 112 via payment rails associated therewith, which may be used in the processing of a payment transaction.

The processing server 102 may also include a memory 224. The memory 224 may be configured to store data for use by the processing server 102 in performing the functions discussed herein, such as public and private keys, symmetric keys, etc. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 224 may be comprised of or may otherwise include a relational database that utilizes structured query language for the storage, identification, modifying, updating, accessing, etc. of structured data sets stored therein. The memory 224 may also include application program data, such as for a digital conversation application program used in the exchange of natural language messages between the processing server 102 and computing device 106, and any other specially configured application programs suitable for performing the functions discussed herein.

### Process for Ordering and Customization via Conversational Interface

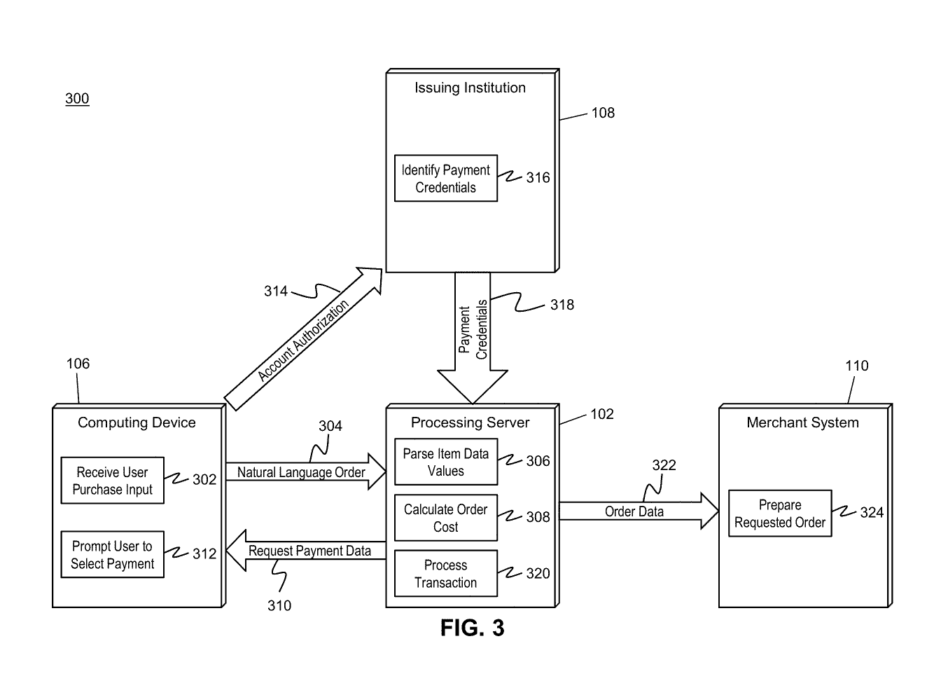

FIG. 3 illustrates a method 300 for the ordering and customization of items via a conversational interface in the system 100.

In step 302, the computing device 106 may receive input from the user 104 requesting the purchase of one or more items. The input may be comprised of one or more natural language messages that are entered by the user 104 into the computing device 106 via suitable input devices. In step 304, the natural language messages comprising the user's order may be electronically transmitted to the processing server 102 via a digital conversation participated in by the computing device 106 and the processing server 102. In step 306, the parsing module 218 of the processing server 102 may parse the received natural language messages to identify one or more natural language data values therefrom.

In step 308, the calculation module 220 of the processing server 102 may calculate a transaction amount for the order requested by the user 104. The calculation may be based on the item costs included in a plurality of item data entries 208 identified in the item database 206 (e.g., via a query executed by the querying module 216) that include natural language values that correspond to those parsed from the natural language messages received from the computing device 106. In step 310, the transmitting device 222 of the processing server 102 may electronically transmit a conversation message (e.g., in natural language) to the computing device 106 as part of the digital conversation, where the conversation message indicates the price for the transaction and requests payment credentials.

In step 312, the computing device 106 may prompt the user 104 to select a transaction account for use in funding the payment transaction. In step 314, the computing device 106 may electronically transmit a data message to the issuing institution 108 that indicates authorization for use of the transaction account selected by the user 104. The message may include, for example, authentication data and an indication of the payment transaction, such as a transaction identifier provided by the processing server 102 to the computing device 106 (e.g., in the request for payment credentials) or to the issuing institution 108. The issuing institution 108 may receive the message and, in step 316, may identify payment credentials associated with the selected transaction account. In step 318, the issuing institution 108 may electronically transmit the identified payment credentials to the processing server 102 and received by the receiving device 202 thereof.

In step 320, the processing server 102 may process a payment transaction for payment of the transaction amount from the transaction account selected by the user 104 to the merchant. The processing may include the electronic transmission (e.g., via the transmitting device 222) of an authorization request from the processing server 102 to the payment network 112 via the payment rails associated therewith, which may include data elements configured to store the transaction amount, payment credentials, and any additional transaction data. The processing may also include receiving (e.g., via the receiving unit 202) an authorization response from the payment network 112 that includes a response code indicating successful processing of the payment transaction. In step 322, the transmitting device 222 of the processing server 102 may electronically transmit the item identifiers for each of the items being ordered by the user 104 (e.g., identified in the related item data entries 208) and any additional natural language values for use by the merchant in fulfillment of the order as well as an indication that the payment transaction was processed successfully to the merchant system 110. In step 324, the merchant system 110 may prepare the order requested by the user 104.

### Graphical User Interface

FIGS. 4A-4D illustrates an example graphical user interface of the computing device 106 for displaying a digital conversation between the user 104 and the processing server 102 for placing and customizing an order from a merchant associated with the merchant system 110 in the system 100. It will be apparent to persons having skill in the relevant art that the interface of the computing device 106 illustrated in FIG. 4 is provided as an illustration only, and that other graphical interfaces may be suitable for performing the functions discussed herein.

The computing device 102 may include a display device 400. The display device 400 may be configured to display a digital conversation 402, such as may be displayed via a messaging application executed by a processor of the computing device 106. The digital conversation may include one or more messages 406 from the processing server 102, and one or more messages 408 submitted by the user 104 as a user of the computing device 106 (e.g., via an input device thereof).

As illustrated in FIGS. 4A-4D, the digital conversation 402 may include messages regarding the purchase of several items from the merchant by the user 104. As illustrated, the processing server 102 (e.g., via a chatbot thereof) prompts the user 104 throughout the digital conversation 402 with respect to items being ordered and customization of those items. The processing server's messages 406 directly address the instructions provided by the user 104 as well as answer questions posed by the user 104 (e.g., “What kinds of cheese can I get?”). The messages 406 may be procedurally generated based on the messages 408 provided by the user 104 or may be previously stored messages that are identified based on the messages 408 provided by the user, such as via querying of an appropriate memory 222 by the querying module 216 of the processing server 102. In the example, the user 104 requests a sandwich with a drink, and wants to use payment credentials previously provided (e.g., and stored by the processing server 102 or with the merchant system 110). The user 104 also indicates that they want to order from the closest merchant location, which the processing server 102 may identify using geographic location information provided by the computing device 106 using methods that will be apparent to persons having ordinary skill in the art. Following the digital conversation 402, the processing server 102 may electronically transmit item identifiers for the ordered items (e.g., the sandwich and the drink) and any other necessary natural language values (e.g., the sandwich toppings, name of the user 104, etc.) to the merchant system 110 at the 123 Main Street location of Sandwich Shop.

### Exemplary Method for Ordering and Customization via a Conversational Interface

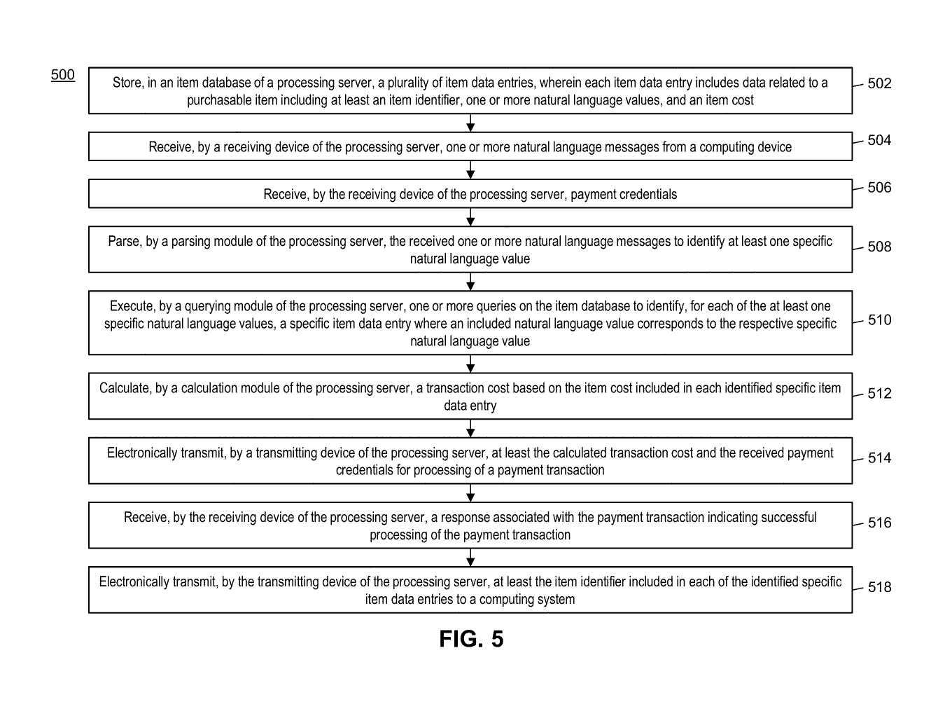

FIG. 5 illustrates a method 500 for the facilitation of a customized order placed by a user with a merchant via third party system using a conversational interface and natural language messaging.

In step 502, a plurality of item data entries (e.g., item data entries 208) may be stored in an item database (e.g., the item database 206) of a processing server (e.g., the processing server 102), wherein each item data entry includes data related to a purchasable item including at least an item identifier, one or more natural language values, and an item cost. In step 504, one or more natural language messages may be received by a receiving device (e.g., the receiving device 202) of the processing server from a computing device (e.g., the computing device 106). In step 506, payment credentials may be received by the receiving device of the processing server.

In step 508, the received one or more natural language messages may be parsed by a parsing module (e.g., the parsing module 218) of the processing server to identify at least one specific natural language value. In step 510, one or more queries may be executed on the item database by a querying module (e.g., the querying module 216) of the processing server to identify, for each of the at least one specific natural language values, a specific item data entry where an included natural language value corresponds to the respective specific natural language value. In step 512, a transaction cost may be calculated by a calculation module (e.g., the calculation module 220) of the processing server based on the item cost included in each identified specific item data entry.

In step 514, at least the calculated transaction cost and the received payment credentials may be electronically transmitted by a transmitting device (e.g., the transmitting device 222) of the processing server for processing of a payment transaction. In step 516, a response associated with the payment transaction that indicates successful processing of the payment transaction may be received by the receiving device of the processing server. In step 518, at least the item identifier included in each of the identified specific item data entries may be electronically transmitted by the transmitting device of the processing server to a computing system (e.g., the merchant system 110).

In one embodiment, one of the at least one specific natural language values may include a computing system identifier and the computing system may be associated with the computing system identifier. In some embodiments, the method 500 may further include parsing, by the parsing module of the processing server, the received one or more natural language messages to further identify purchaser information, wherein the purchaser information may be electronically transmitted to the computing system with the item identifiers. In a further embodiment, the purchaser information includes at least one of: purchaser name, delivery address, and pick-up time.

In one embodiment, the payment credentials may be received from the computing device. In another embodiment, the payment credentials may be received from a third party system. In some embodiments, the calculated transaction cost and the received payment credentials may be stored in data elements included in a transaction message that is electronically transmitted to a payment network. In a further embodiment, the transaction message may be an authorization request formatted pursuant to one of: ISO 8583 and ISO 20022.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3 and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for facilitating payment through an encoded link. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for ordering and customization via a conversational interface, comprising:
storing, in an item database of a processing server, a plurality of item data entries, wherein each item data entry includes data related to a purchasable item including at least an item identifier, one or more natural language values, and an item cost;
receiving, by a receiving device of the processing server, one or more natural language messages from a computing device;
receiving, by the receiving device of the processing server, payment credentials;
parsing, by a parsing module of the processing server, the received one or more natural language messages to identify at least one specific natural language value;
executing, by a querying module of the processing server, one or more queries on the item database to identify, for each of the at least one specific natural language values, a specific item data entry where an included natural language value corresponds to the respective specific natural language value;
calculating, by a calculation module of the processing server, a transaction cost based on the item cost included in each identified specific item data entry;
electronically transmitting, by a transmitting device of the processing server, at least the calculated transaction cost and the received payment credentials for processing of a payment transaction;
receiving, by the receiving device of the processing server, a response associated with the payment transaction indicating successful processing of the payment transaction; and
electronically transmitting, by the transmitting device of the processing server, at least the item identifier included in each of the identified specific item data entries to a computing system.

2. The method of claim 1, wherein
one of the at least one specific natural language values includes a computing system identifier,
the computing system is associated with the computing system identifier.

3. The method of claim 1, further comprising:
parsing, by the parsing module of the processing server, the received one or more natural language messages to further identify purchaser information, wherein
the purchaser information is electronically transmitted to the computing system with the item identifiers.

4. The method of claim 3, wherein the purchaser information includes at least one of: purchaser name, delivery address, and pick-up time.

5. The method of claim 1, wherein the payment credentials are received from the computing device.

6. The method of claim 1, wherein the payment credentials are received from a third party system.

7. The method of claim 1, wherein the calculated transaction cost and the received payment credentials are stored in data elements included in a transaction message that is electronically transmitted to a payment network.

8. The method of claim 7, wherein the transaction message is an authorization request formatted pursuant to one of: ISO 8583 and ISO 20022.

9. A system for ordering and customization via a conversational interface, comprising:
an item database of a processing server configured to store a plurality of item data entries, wherein each item data entry includes data related to a purchasable item including at least an item identifier, one or more natural language values, and an item cost;
a receiving device of the processing server configured to receive one or more natural language messages from a computing device, and payment credentials;
a parsing module of the processing server configured to parse the received one or more natural language messages to identify at least one specific natural language value;
a querying module of the processing server configured to execute one or more queries on the item database to identify, for each of the at least one specific natural language values, a specific item data entry where an included natural language value corresponds to the respective specific natural language value;
a calculation module of the processing server configured to calculate a transaction cost based on the item cost included in each identified specific item data entry; and
a transmitting device of the processing server configured to electronically transmit at least the calculated transaction cost and the received payment credentials for processing of a payment transaction, wherein
the receiving device of the processing server is further configured to receive a response associated with the payment transaction indicating successful processing of the payment transaction, and
the transmitting device of the processing server is further configured to electronically transmit at least the item identifier included in each of the identified specific item data entries to a computing system.

10. The system of claim 9, wherein
one of the at least one specific natural language values includes a computing system identifier,
the computing system is associated with the computing system identifier.

11. The system of claim 9, wherein
the parsing module of the processing server is further configured to parse the received one or more natural language messages to further identify purchaser information, and
the purchaser information is electronically transmitted to the computing system with the item identifiers.

12. The system of claim 11, wherein the purchaser information includes at least one of: purchaser name, delivery address, and pick-up time.

13. The system of claim 9, wherein the payment credentials are received from the computing device.

14. The system of claim 9, wherein the payment credentials are received from a third party system.

15. The system of claim 9, wherein the calculated transaction cost and the received payment credentials are stored in data elements included in a transaction message that is electronically transmitted to a payment network.

16. The system of claim 15, wherein the transaction message is an authorization request formatted pursuant to one of: ISO 8583 and ISO 20022.
